(19) United States
(12) Patent Application Publication
(10) Pub. No.: US 2005/0143091 A1
(43) Pub. Date: Jun. 30, 2005

(54) Indoor location identification system

(76) Inventors: Yair Shapira, Shoham (IL); Yehuda Holtzman, Mazkeret Batia (IL)

Correspondence Address: DR. MARK FRIEDMAN LTD.;C/o Bill Polkinghorn, Discovery Dispatch, 9003 Florin Way, Upper Marlboro, MD, 20772, US

(21) Appl. No.: 10/928,245

(22) Filed: Aug. 30, 2004

Related U.S. Application Data
(60) Provisional application No. 60/499,009, filed on Sep. 2, 2003.

(51) Int. Cl. H04Q 7/20

(52) U.S. Cl. 455/456.1

(57) ABSTRACT

A system and method or accurate location identification of a mobile cellular telephone in an indoor environment in case of emergency are provided. The system comprises elements of a distributed antenna system (DAS) and at least one location identification unit (LIU) coupled to the DAS and operative to extract the location of the mobile cellular telephone from RF signals obtained from the DAS. The LIU includes a receiver operative to receive the signals, preferably from a base unit (BU) of the DAS, and a processor operative to process the signals. The LIU obtains parameters of the emergency call that define a tuning window from an external system, and, using the tuning window, identifies a remote hub unit (RHU) of the DAS with the highest signal energy at the tuning window as the RHU through which the call was acquired. The location of the mobile cellular telephone is then determined as being in the area covered by this RHU.

### CROSS REFERENCE TO RELATED APPLICATIONS

The present invention claims priority from U.S. Provisional Patent Application No. 60/499,009 filed 2 Sep., 2003, the content of which is incorporated herein by reference.

### FIELD AND BACKGROUND OF THE INVENTION

The present invention relates to emergency location services, and in particular to methods and systems for locating individuals inside buildings during emergencies in real time, using cellular technology.

It is expected that within 3-5 years, 50% of cellular calls will be conducted inside buildings. The cellular coverage level in many buildings is not adequate to guarantee a successful call session. Reception of cellular signals in buildings is disturbed because:

1) Building obstructions (exterior and interior walls) attenuate the signal below the level required for maintaining a link.

2) In high floors (usually above the clutter), a mobile cellular telephone is exposed to multiple base station signals that create “co-channel interference” or “pilot pollution”.

An internal coverage system is often deployed to overcome coverage problems inside buildings. The most common internal coverage system has a Distributed Antenna System (DAS) architecture in which the antenna output of a base station or a repeater is connected through a coaxial network or fiber network (or combined coaxial and fiber network) to a set of indoor antennas. FIG. 1 shows an exemplary prior art DAS architecture 100 in which the system is built in a “star” configuration, where a single base station 101 feeds two buildings 102 and 104 through two respective base units (BU) 106 and 108 and through (exemplarily) eight remote hub units (RHU) 110a-d and 112a-d. Base units are sometimes called central hub units or base hub units, and are characterized by being a central distribution point for multiple remote units. RHUs are sometimes called remote access units (RAUs) or by other names. A RHU is a local distribution point for at least one antenna. Typically, one RHU covers a floor of a building. Exemplarily, in FIG. 1 RHU 110a covers a floor 114a, RHU 110b covers a floor 114b, RHU 110c covers a floor 114c, and RHU 110d covers a floor 114d of building 102. Typical installations of such systems are in airports, commercial centers, shopping malls, corporate and high education campuses, hospitals, and other major sites.

In many cases, a single base station feeds several buildings located hundreds of yards or sometimes even more than a mile apart. Sometimes the buildings themselves are large horizontal constructions, with at least one dimension larger than 100 meters. In other cases, a DAS is fed by an “over the air repeater” that uses a “donor” base station which may be 1-3 miles remote from the covered building. It is obvious that location identification based on any kind of triangulation is not possible in such cases since the subscriber unit is received only by one base station by definition.

Multi-floor buildings pose additional obstacles for indoor location identification, as they require three-dimensional positioning. Even if the longitude and latitude of an individual cellular telephone in a fifty floor high building were known with great accuracy, that knowledge would be insufficient because an emergency team would have to search every floor. For an accuracy of 200 meters, the location fix may cover many multi-floor buildings. Under these conditions, a rescue team could spend hours just searching for the caller.

Several technologies have been proposed for outdoor location identification, including network-based technologies, e.g. Time Difference of Arrival (TDOA) and others, and handset-based technologies such as the Assisted Global Positioning System (AGPS). All these technologies are flawed in terms of their ability to locate indoor cellular callers. Large steel and concrete buildings, subways and large malls may be difficult or even impossible to cover using traditional wide area location technologies such as AGPS and TDOA. Low signal levels and signal multipath effects in these environments decrease the location identification accuracy or totally prevent signal acquisition. None of these technologies can locate a cellular telephone indoors, due to the low signal levels and the fact that these technologies provide in effect only a two-dimensional location identification, where a three-dimensional one is needed.

There is therefore a need for, and it would be advantageous to have a simple and reliable solution for real-time accurate indoor location of a mobile cellular telephone in case of an emergency.

### SUMMARY OF THE INVENTION

The present invention is of a system and method for accurate indoor location of a mobile cellular telephone (cellular user) (or simply “indoor location identification”) in case of an emergency in real time. The invention uses an existing DAS-like infrastructure to extract the location of the cellular user from the energy of radio frequency (RF) signals gathered through the antennas of the infrastructure. The DAS-like infrastructure may also serve (but does not have to) as a regular DAS. The RF signals are tapped into and processed by a location identification unit (LIU) coupled to the DAS. Preferably, the LIU taps into the DAS at a most convenient tapping point, most preferably near a base unit that concentrates the RF signals received from a plurality of remote hub units. Preferably, a separate LIU is coupled to each BU. Alternatively, a single LIU may be coupled to a plurality of BUs. The energy of RF signals is processed by a processor in the LIU to provide the location of the mobile cellular telephone, by identifying the RHU with the highest received energy at the channel frequency and time slot (or code) of the emergency call.

According to the present invention there is provided a system for accurate location of a mobile cellular telephone in an indoor environment, comprising: a DAS that includes a plurality of antennas located in known areas of the indoor environment; and at least one location identification unit coupled to the DAS and operative to extract a location of the mobile cellular telephone from the energy of RF signals obtained from the mobile cellular telephone.

According to the present invention there is provided a method for locating a mobile cellular user inside an indoor environment comprising the steps of obtaining RF signals from a plurality of antennas of a distributed antenna system located inside the indoor environment, and extracting the location of the mobile cellular user from the energy of the RF signals.

According to one feature in the method for locating a mobile cellular user inside an indoor environment, the step of obtaining RF signals includes using at least one LIU to tap into the DAS to receive the RF signals, and the step of extracting the location includes obtaining parameters of the emergency call, and identifying a RHU with the highest signal energy that matches the call parameters.

According to the present invention there is provided a method for identifying the indoor location of a mobile cellular telephone in case of an emergency, comprising the steps of acquiring an RF signal originated by the mobile cellular telephone through an indoor DAS that includes at least one RHU connected to at least one antenna, and identifying a specific RHU through which the RF signal was acquired.

According to one feature in the method for identifying the indoor location of a mobile cellular telephone in case of an emergency, the step of acquiring includes using a location identification unit to tap into the DAS to obtain the RF signal, and the step of identifying includes identifying the RF signal as belonging to an emergency call, providing the parameters of the emergency call to a processor inside a location identification unit, and identifying a RHU with highest signal energy at a tuning window defined by the call parameters.

### BRIEF DESCRIPTION OF THE DRAWINGS

The invention is herein described, by way of example only, with reference to the accompanying drawings, wherein:

FIG. 1 shows a prior art distributed antenna system architecture;

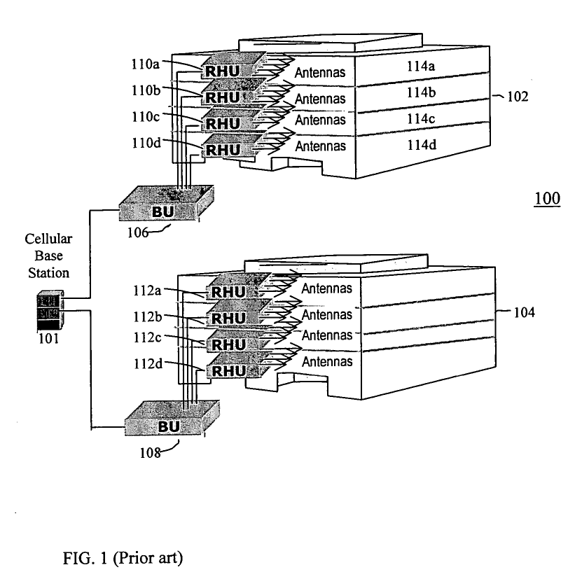

FIG. 2 shows a preferred embodiment of an indoor locating system of the present invention;

FIG. 3 shows details of the internal structure of a base unit and a location identification unit.

### DESCRIPTION OF THE PREFERRED EMBODIMENTS

The present invention is of a system and method for accurate location, in real time, of a mobile cellular telephone in an indoor environment during emergencies (e.g. upon a “911” emergency call). The invention is based advantageously on the fact that a distributed antenna system can be used to monitor the RF signals received in each floor or area of each building covered by the DAS, specifically by the RHU covering that floor or area. The RHU identified with a particular emergency call indicates the location from which the call is made. Such a use of a DAS or DAS-like infrastructure is unknown in prior art, as well as unexpected. The indoor location identification system of the present invention can interface with existing distributed antenna systems, and can, upon request, provide information on the location of an indoor subscriber.

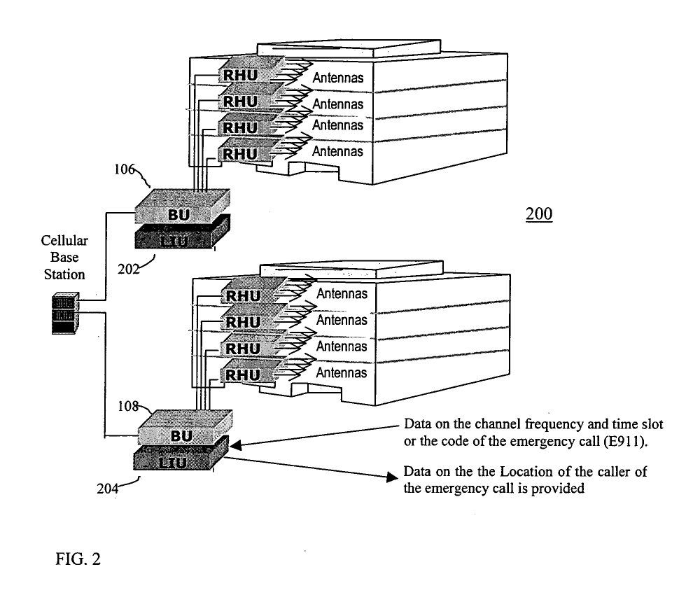

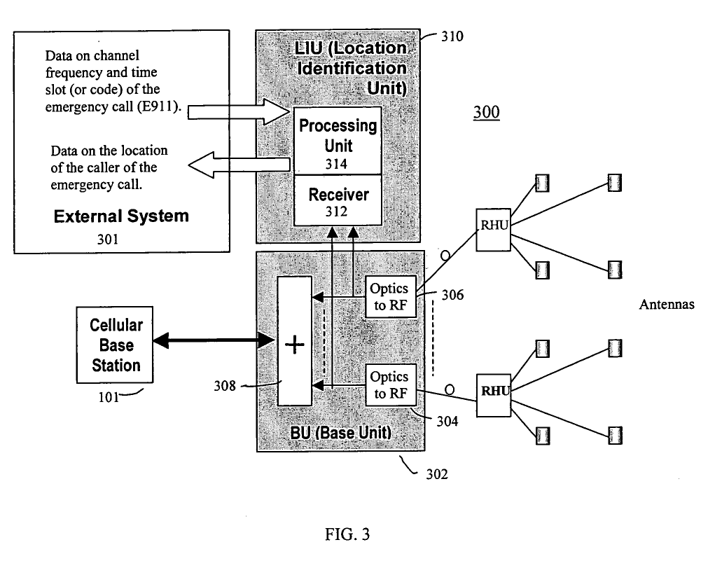

FIG. 2 shows a preferred embodiment of an indoor location identification system 200 of the present invention. System 200 is shown exemplarily in conjunction with DAS 100. System 200 comprises, in addition to the elements of DAS 100, at least one location identification unit (LIU) that is operative to extract the location of a mobile cellular telephone located indoors, by processing the energy of RF signals obtained from the DAS. The energy of the RF signals is obtained by the LIU by tapping into the DAS. The tapping may be done at different point of the DAS. However, preferably, the tapping is done close to a BU, which concentrates all RF signals from a plurality of RHUs connected thereto. In FIG. 2, a LIU 202 is connected to BU 106, and a LIU 204 connected to BU 108 of DAS system 100. Each LIU monitors the signals received from a group of floors (or areas) in a building served by the respective BU. Alternatively, a single LIU can be configured to be connected to a plurality of BUs and to monitor RF signals received from a group of floors (or areas) in the building served by a respective plurality of BUs. An emergency call is identified by data that includes the channel frequency and either a time slot or a code. These data are referred to herein also as “tuning parameters” which defines a “tuning window”. The tuning parameters are provided to the LIU by an external system (see FIG. 3). The LIU then searches all RHUs to identify the RHU with the highest signal energy at the tuning window (channel frequency and time slot or code). This RHU is then assumed as the RHU receiving the emergency call, and the location of the caller is identified as lying in the area covered by this RHU.

FIG. 3 shows details of the internal structure of a base unit and a location identification unit. A base unit 302 comprises exemplarily two optics-to-RF transformer units 304 and 306 operative to receive optical signals from a RHU and convert them into RF signals for transmission to cellular base station 101, and a RF combiner 308 that combines the RF signals before their transmission to the base station. A LIU 310 comprises a receiver 312 operative to receive the RF signals from BU 302, and a processing unit 314 operative to process the these signals, and to communicate bi-directionally with at least one external system 301. The external system provides the channel frequency and time slot of the emergency call in case of time division multiple access (TDMA), or the channel frequency and code of the emergency call in the case of code division multiple access (CDMA). An external system according to the present invention may be a location identification system for the macro-network. As well known, this is a system that enables locating emergency calls outside of buildings. It identifies the fact that an emergency call has been made, and provides information on the frequency and time slot (or code) to the relevant equipment (in this case the LIU). Alternatively, an external system may include other elements or combination of elements of the cellular network, referred to collectively herein as a “subsystem” of the cellular network.

The processing unit in the LIU provides the following functionality:
a) interfaces between the external system and the LIU. The external system provides a required channel frequency and time slot, or a required channel frequency and code related to the emergency call;
b) tunes the receiver to the required channel frequency and time slot, or channel frequency and code (“tuning window”);
c) measures, at the tuning window, the signal energy received from each RHU;
d) identifies, by comparison, which RHU has received the highest energy;
e) determines the location of the handset (cellular telephone) that conducts the emergency call in the coverage area of the RHU that received the highest energy at the given tuning window; and
f) provides to the external system the location of the mobile cellular telephone that conducts the emergency call.

Preferably, the processing unit is a microprocessor-based equipment with memory and other required peripherals.

In use, a call initiated in any of the buildings by a mobile cellular telephone is received by the DAS system, transferred to the cellular base station and further transferred to the cellular core network (not shown), where the dialed number is decoded, and a channel frequency and time slot (or code) are assigned to the call in well-known procedures. If the dialed number is an emergency number (e.g. 911) this information (of the call being an emergency call) plus the channel frequency and time slot (or code) of the call are provided to all the LIUs connected to the respective cellular base station through which the call was received. Each LIU, connected to a respective BU, is then tuned to the provided channel frequency and time slot (or code), and operated to scan through the inputs of all the RHUs connected to the respective BU. The LIU then determines which of the RHUs connected to the respective BU received the call, by measuring the energy at a tuning window defined by the provided channel frequency and time slot (or code). Since each RHU is assigned to a specific building/floor/area, the system can locate the building and/or floor and/or area from which the emergency call was originated.

An alternative technique may be used in order to shorten the time required for identification. According to this technique, the receiver (e.g. 312) in a LIU (e.g. 310) continuously monitors the output of the RHUs connected to its associated BU (e.g 302) and registers the characteristics (frequency/time slot/code) of the received signals. The receiver functions in this case like a well-known spectrum analyzer that searches a given frequency band in which the cellular transmissions are made, identifies received signals and records them. Whenever the information on an emergency call is provided to the LIU, the LIU searches its records for matching characteristics (i.e. same frequency/time slot/code) and responds immediately with the designation of the RHU that received the signal.

While the invention has been described with respect to a limited number of embodiments, it will be appreciated that many variations, modifications and other applications of the invention may be made.

1. A system for accurate locating of a mobile cellular telephone in an indoor environment, comprising:
a. a distributed antenna system (DAS) that includes at least one remote hub unit (RHU) connected to at least one antenna located in a known area of the indoor environment; and
b. at least one location identification unit (LIU) coupled to said DAS and operative to extract a location of the mobile cellular telephone from radio frequency (RF) signals obtained from said DAS.

2. The system of claim 1, wherein said DAS includes at least one base unit (BU) coupled to said at least one RHU and to a cellular base station and operative to receive said RF signals through said at least one RHU and to provide said RF signals to said at least one LIU, and wherein said LIU includes:
i. a receiver operative to receive said RF signals from said at least one BU; and
ii. a processor coupled to said receiver and operative to process said RF signals and to obtain respective signal energies, said processor further operative to communicate bi-directionally with at least one external system that provides emergency call parameters required to tune said receiver to a specific tuning window,
whereby said at least one LIU identifies the RHU that received said emergency call by identifying the RHU with the highest signal energy in said specific tuning window, thereby providing the location from which the emergency call was originated.

3. The system of claim 2, wherein said external system includes a location identification system for a macro-network

4. The system of claim 2, wherein said external system includes a subsystem of a cellular network.

5. A method for locating a mobile cellular telephone inside an indoor environment comprising the steps of:
a. obtaining radio frequency (RF) signals from a distributed antenna system (DAS) having at least one remote hub unit (RHU) connected to at least one antenna located inside the indoor environment; and
b. extracting the location of the mobile cellular telephone from said RF signals.

6. The method of claim 5, wherein said step of obtaining RF signals includes:
i. using at least one location identification unit (LIU) to tap into said DAS to receive RF signals identifiable as emergency call signals, and wherein said step of extracting includes
i. obtaining from an external system coupled to said at least one LIU a channel frequency and an additional parameter of said emergency call, said channel frequency and said additional parameter defining a tuning window, and
ii. using said LIU to scan said each said at least one RHU for a highest signal energy in said tuning window.

7. The method of claim 5, wherein said step of obtaining RF signals includes:
i. using at least one location identification unit (LIU) to tap into said DAS to receive RF signals identifiable as emergency call signals, and wherein said step of extracting includes
i. obtaining from an external system coupled to said at least one LIU a channel frequency and an additional parameter of said emergency call,
ii. using said LIU to continuously monitor each output of each said at least one RHU and to register characteristics of said RF received signals, and
iii. matching said channel frequency and said additional parameter of said emergency call with said registered characteristics to identify one of said at least one RHU through which said emergency call was received.

8. The method of claim 6, wherein said using at least one LIU to tap into said DAS system further includes connecting each said LIU to a respective base unit (BU) that receives said RF signals from each said at least one said RHU.

9. The method of claim 6, wherein said step of extracting further includes tuning a receiver included in each said LIU to said channel frequency and said additional parameter;

10. The method of claim 6, wherein said obtaining an additional parameter includes obtaining a time slot of said call.

11. The method of claim 6, wherein said obtaining an additional parameter includes obtaining a code of said call.

12. The method of claim 7, wherein said step of extracting further includes tuning a receiver included in each said LIU to said channel frequency and said additional parameter;

13. The method of claim 7, wherein said obtaining an additional parameter includes obtaining a time slot of said call.

14. The method of claim 7, wherein said obtaining an additional parameter includes obtaining a code of said call.

15. The method of claim 6, wherein said obtaining a channel frequency and an additional parameter includes obtaining said channel frequency and said additional parameter from a location identification system for a macro-network.

16. The method of claim 6, wherein said obtaining a channel frequency and an additional parameter includes obtaining said channel frequency and said additional parameter from a subsystem of a cellular network.

17. The method of claim 6, further comprising the step of providing to said external system a location of said mobile cellular telephone.

18. A method for identifying the indoor location of a mobile cellular telephone in case of an emergency, comprising the steps of:
a. acquiring an RF signal originated by the mobile cellular telephone through an indoor distributed antenna system (DAS) that includes at least one remote hub unit (RHU) connected to at least one said antenna; and
b. identifying a specific said at least one RHU through which said RF signal was acquired.

19. The method of claim 18, wherein said step of acquiring includes:
i. using a location identification unit (LIU) to tap into said DAS to obtain said RF signal, and wherein said step of identifying includes
i. identifying said RF signal as belonging to an emergency call,
ii. obtaining a tuning window of said emergency call, and
iii. identifying said specific RHU as having a highest signal energy at said tuning window.

20. The method of claim 19, wherein said LIU includes a receiver operative to receive said RF signal and a processor operative to process said RF signal and to interface with an external system, wherein said obtaining a tuning window of said emergency call includes obtaining said tuning window by said processor from said external system.

21. The method of claim 18, wherein said step acquiring includes
i. using at least one location identification unit (LIU) to tap into said DAS and to continuously monitor each output of each said at least one RHU and to register characteristics of each said RF signal,
and wherein said step of identifying includes
i. obtaining from an external system coupled to said at least one LIU a channel frequency and an additional parameter of an emergency call, and
ii. matching said channel frequency and said additional parameter of said emergency call with said registered characteristics to identify one of said at least one RHU through which said emergency call was received.

22. The method of claim 20, further comprising providing the location of said identified specific RHU to said external system.
